(19) United States
(12) Patent Application Publication
(10) Pub. No.: US 2025/0135962 A1
(43) Pub. Date: May 1, 2025

(54) BACKREST AND DEVICE FOR DETECTING THE SIZE OF A SEAT OCCUPANT

(71) Applicant: FAURECIA Sièges d'Automobile, NANTERRE (FR)

(72) Inventors: Mamadou BALDE, MORIGNY-CHAMPIGNY (FR); Abdou Latif DJIRAM, CHILLY-MAZARIN (FR); Theo DESGROLARD, PALAISEAU (FR)

(21) Appl. No.: 18/931,744

(22) Filed: Oct. 30, 2024

(30) Foreign Application Priority Data
Oct. 31, 2023 (FR) 2311863

(51) Int. Cl. B60N 2/00

(52) U.S. Cl. CPC B60N 2/0022; B60N 2/0033; B60N 2/0034; B60N 2210/12

(57) ABSTRACT

The present disclosure relates to a seat backrest, the backrest extending in a longitudinal direction and a transverse direction, the backrest comprising: at least one first and one second coplanar interdigital electrode capacitive sensor arranged on a first zone of the backrest located above a horizontal central plane and on one side of a vertical central plane; the second capacitive sensor of the first zone being located above the first capacitive sensor of the first zone; the second capacitive sensor of the first zone being advanced by a first distance relative to the first capacitive sensor of the first zone in the direction of the central vertical plane.

### PRIORITY CLAIM

This application claims priority French Patent Application No. FR2311863, filed Oct. 31, 2023, which is expressly incorporated by reference herein.

### BACKGROUND

The present disclosure relates to a backrest, in particular a motor vehicle backrest. The present disclosure also concerns a device for detecting the size of a seat occupant.

### SUMMARY

According to the present disclosure, a seat backrest, in particular a motor vehicle seat backrest, the backrest extending in a longitudinal direction and a transverse direction;
at least one first and one second coplanar interdigital electrode capacitive sensor, referred to as first and second capacitive sensors of the first zone, the capacitive sensors of the first zone being arranged on a first zone of the backrest located above a horizontal central plane and on one side of a vertical central plane;
the second capacitive sensor of the first zone being located above the first capacitive sensor of the first zone;
the second capacitive sensor of the first zone being advanced by a first distance relative to the first capacitive sensor of the first zone in the direction of the central vertical plane.

The features disclosed in the following paragraphs may optionally be implemented. They can be implemented independently of one another or in combination with one another:
the first distance measured in the transverse direction is equal to or greater than 5 millimeters, and preferably equal to or greater than 10 millimeters.
It comprises at least one third coplanar interdigital electrode capacitive sensor, referred to as the third capacitive sensor of the first zone, the third capacitive sensor of the first zone being arranged on the first zone of the backrest, the third capacitive sensor of the first zone being located above the second capacitive sensor of the first zone;
the third capacitive sensor of the first zone being advanced by a second distance relative to the second capacitive sensor of the first zone in the direction of the central vertical plane, the second distance measured in the transverse direction in particular being equal to or greater than 5 millimeters, and preferably equal to or greater than 10 millimeters.
It comprises at least one fourth coplanar interdigital electrode capacitive sensor, referred to as the fourth capacitive sensor of the first zone, the fourth capacitive sensor of the first zone being arranged on the first zone of the backrest, the fourth capacitive sensor of the first zone being located above the third capacitive sensor of the first zone;
the fourth capacitive sensor of the first zone being advanced by a third distance relative to the third capacitive sensor of the first zone in the direction of the central vertical plane, the third distance measured in the transverse direction in particular being equal to or greater than 5 millimeters, and preferably equal to or greater than 10 millimeters.
two capacitive sensors of the first zone, arranged side by side in the longitudinal direction, are spaced apart by a gap of between 5 millimeters and 20 millimeters.
It further comprises at least one first and one second capacitive sensor of the second zone, the first and second capacitive sensors of the second zone being arranged on a second zone of the backrest, the second zone being located above the horizontal central plane and on the other side of the vertical central plane;
the second capacitive sensor of the second zone being located above the first capacitive sensor of the second zone;
the second capacitive sensor of the second zone being advanced by a fourth distance relative to the first capacitive sensor of the second zone in the direction of the central vertical plane, the fourth distance measured in the transverse direction in particular being equal to or greater than 5 millimeters, and preferably equal to or greater than 10 millimeters.
It comprises at least one third coplanar interdigital electrode capacitive sensor, referred to as the third capacitive sensor of the second zone, the third capacitive sensor of the second zone being arranged on the second zone of the backrest, the third capacitive sensor of the second zone being located above the second capacitive sensor of the second zone;
the third capacitive sensor of the second zone being advanced by a fifth distance relative to the second capacitive sensor of the second zone in the direction of the central vertical plane, the fifth distance being measured in the transverse direction, the fifth distance in particular being equal to or greater than 5 millimeters, and preferably equal to or greater than 10 millimeters.
It comprises at least one fourth coplanar interdigital electrode capacitive sensor, referred to as the fourth capacitive sensor of the second zone, the fourth capacitive sensor of the second zone being arranged on the second zone of the backrest, the fourth capacitive sensor of the second zone being located above the third capacitive sensor of the second zone;
the fourth capacitive sensor of the second zone being advanced by a sixth distance relative to the third capacitive sensor; the sixth distance, measured in the transverse direction, is in particular equal to or greater than 5 millimeters, and preferably equal to or greater than 10 millimeters.
At least two capacitive sensors of the first zone and two capacitive sensors of the second zone are arranged symmetrically to one another, relative to the central vertical plane.
It further comprises electrical connection wires each connected to a capacitive sensor of the first zone and/or a capacitive sensor of the second zone, and a flexible support carrying the capacitive sensors and the electrical connection wires, part of the flexible support being arranged on an upper edge of the backrest, next to the headrest.
At least one coplanar interdigital electrode capacitive sensor comprises a first electrode and a second electrode, the first electrode and the second electrode each comprising a rod extending in a main direction, and branches secured to the rod, the branches extending in a secondary direction, the secondary direction being perpendicular to the main direction;
the branches of the first electrode being separated from one another by the same interval, the branches of the first electrode being interposed between the branches of the second electrode, the rod and branches of at least one of the first and second electrodes having a dimension in the main direction of between 250 micrometers and 1000 micrometers, preferably between 500 micrometers and 800 micrometers.
The branches of at least one of the first and second electrodes have a dimension in the secondary direction of between 3 and 20 millimeters, preferably between 3 and 7 millimeters.
The branches of the first electrode comprise free ends, and wherein a free end of a branch of the first electrode is spaced apart from a facing rod portion of the second electrode by a spacing of between 250 micrometers and 1000 micrometers, and preferably between 500 micrometers and 800 micrometers.

The present disclosure also relates to a device for detecting the size of an occupant of a seat, in particular a motor vehicle seat, the detection device comprising:
at least one flexible support in the form of a strip with two lateral edges, the flexible support extending in a longitudinal direction;
at least one first and one second coplanar interdigital electrode capacitive sensor, referred to as first and second capacitive sensors, and
electrical connection wires connected to the first and second capacitive sensors and extending in the longitudinal direction, the first and second capacitive sensors extending perpendicular to the longitudinal direction;
the second capacitive sensor being advanced by a first distance from the first capacitive sensor in the direction of a lateral edge, the first distance, measured in a transverse direction, being equal to or greater than 5 millimeters, and preferably equal to or greater than 10 millimeters.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagram showing a seat with a backrest according to the present disclosure;

FIG. 2 is a perspective view of a portion of the backrest shown in FIG. 1;

FIG. 3 is a front view of a coplanar interdigital electrode capacitive sensor arranged on the seat shown in FIG. 1.

### DETAILED DESCRIPTION

In the following description, the spatial positioning indications such as top, bottom, upper, lower, horizontal, vertical, etc. are given for the clarity of the description, based on the usual usage position of the seat, but are not limiting.

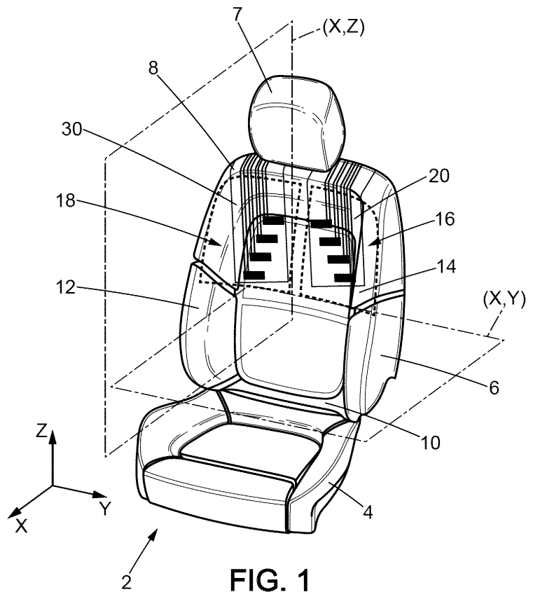

The seat is defined in relation to an orthogonal reference frame shown in FIG. 1. In the longitudinal direction X, a horizontal direction is understood to extend between the front and the rear of the vehicle seat. The transverse direction Y refers to a horizontal direction, extending from one side of the vehicle seat to the other side of the seat. The vertical direction Z means the direction perpendicular to the longitudinal X and transverse Y directions.

FIG. 1 shows an example of a seat 2 comprising a squab 4 and a backrest 6 connected to the squab, for example by an articulation system. In particular, this seat 2 is intended for a vehicle, and in particular a motor vehicle.

The backrest comprises a headrest 7 attached to an upper edge of the backrest.

The backrest 6 comprises a backrest frame, a foam layer covering the backrest frame and a seat cover covering the foam layer. The backrest 6 extends in a transverse direction Y and a longitudinal direction Z.

To facilitate understanding of the present disclosure, a horizontal central plane (X, Y) and a vertical central plane (X, Z) are defined. The horizontal central plane (X, Y) extends horizontally. It passes roughly through the middle of the backrest in the longitudinal direction Z. The middle of the backrest in the longitudinal direction Z is defined by half the length of the backrest. The length of the backrest is measured between an upper edge 8 and a lower edge 10 of the backrest.

The vertical central plane (X, Z) extends vertically. It passes substantially through the middle of the backrest in the transverse direction Y. The middle of the backrest in the transverse direction Y is defined by half the width of the backrest. The width of the backrest is measured between a lateral edge 12 and the opposite lateral edge 14 of the backrest.

Referring to FIG. 1, the seat backrest comprises a first zone 16 and a second zone 18. The first zone 16 is an upper lateral zone located on one side of the central vertical plane (X, Z), for example on the right-hand side. The second zone 18 is an upper lateral zone located on the other side of the central vertical plane (X, Z), for example on the left-hand side. The first and second zones are located above the horizontal central plane (X, Y).

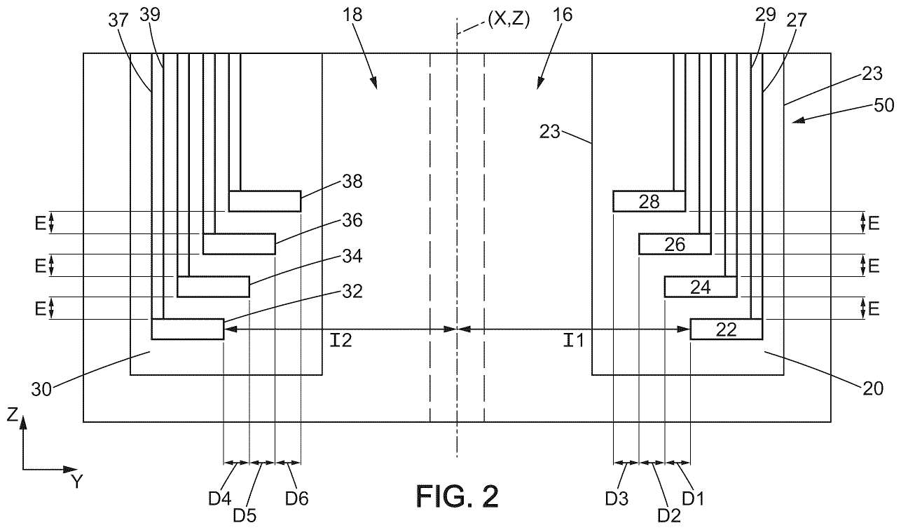

In the example shown in FIGS. 1 and 2, and by no means limitingly, the first zone 16 of the backrest comprises a first flexible support 20, four capacitive sensors 22, 24, 26, 28 with coplanar interdigital electrodes, hereinafter referred to as “capacitive sensors of the first zone”, and electrical connection wires 27, 29.

The capacitive sensors 22, 24, 26, 28 and electrical connection wires 27, 29 are supported by the first flexible support 20.

The electrical connection wires 27, 29 are connected to an electrical connector, not shown.

The first flexible support 20 is in the form of a strip with two lateral edges 23, 25. The first flexible support 20 bears against the foam layer. It extends vertically against the backrest. Part of the first flexible support rests on the upper edge 8 of the backrest on one side of the headrest 7.

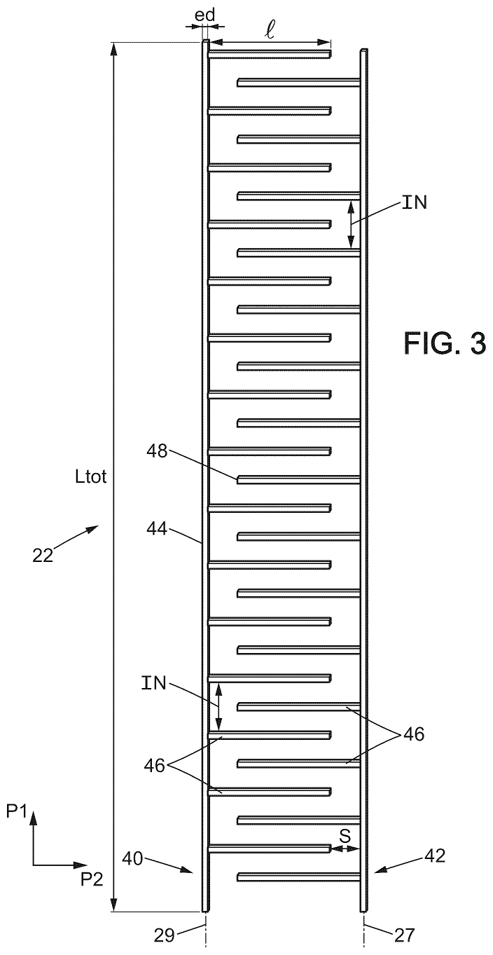

Preferably, the four capacitive sensors 22, 24, 26, 28 of the first zone are identical. They are disclosed in detail below in conjunction with FIG. 3.

For example, a first capacitive sensor 22 of the first zone is located at a first interval I1 from the intersection of the vertical central plane (X, Z) and the plane formed by the seat surface. For example, the first interval I1 is between 4 and 6 centimeters long.

A first and a second capacitive sensor are arranged perpendicular to at least one lateral edge 23, 25. The second capacitive sensor 24 of the first zone is located above the first capacitive sensor 22 of the first zone. The second capacitive sensor 24 of the first zone is advanced by a first distance D1 relative to the first capacitive sensor 22 of the first zone in the direction of the vertical central plane (X, Z). In this description, the term “advanced” means “having been shifted”, “having been translated”, “having been moved” in relation to the first capacitive sensor 22 of the first zone in the transverse direction Y and in the direction of the vertical central plane (X, Z). In other words, the second capacitive sensor 24 of the first zone is closer to the vertical central plane (X, Z) by a spacing having a length equal to the first distance D1. The first distance D1 is measured in the transverse direction Y. The first distance D1 is equal to or greater than 5 millimeters, and preferably it is equal to or greater than 10 millimeters.

The first capacitive sensor 22 of the first zone is spaced apart from the second capacitive sensor 24 of the first zone by a gap E in the longitudinal direction Z. The gap E is preferably between 5 millimeters and 20 millimeters.

Similarly, a third capacitive sensor 26 of the first zone is arranged on the first zone 16 of the backrest. The third capacitive sensor 26 of the first zone is located above the second capacitive sensor 24 of the first zone. The third capacitive sensor 26 of the first zone is advanced by a second distance D2 relative to the second capacitive sensor 24 of the first zone in the direction of the vertical central plane (X, Z). The second distance is measured in the transverse direction Y. The second distance D2 is equal to or greater than 5 millimeters, and preferably equal to or greater than 10 millimeters.

The second capacitive sensor 24 of the first zone is spaced apart from the third capacitive sensor 26 of the first zone by the gap E in the longitudinal direction Z. In the embodiment shown, the gap E between the second capacitive sensor 24 and the third capacitive sensor 26 is identical to the gap between the first capacitive sensor 22 and the second capacitive sensor 24. According to a variant not shown, these gaps have different lengths.

Finally, in the same way, a fourth capacitive sensor 28 of the first zone is located above the third capacitive sensor 26 of the first zone. The fourth capacitive sensor 28 of the first zone is advanced by a third distance D3 relative to the third capacitive sensor 26 of the first zone in the direction of the vertical central plane (X, Z). The third distance D3 is measured in the transverse direction Y. The third distance D3 is equal to or greater than 5 millimeters, and preferably equal to or greater than 10 millimeters.

The third capacitive sensor 26 of the first zone is spaced apart from the fourth capacitive sensor 28 of the first zone by the gap E in the longitudinal direction Z. In the embodiment shown, the gap E between the third capacitive sensor 26 and the fourth capacitive sensor 28 is identical to the gap between the first capacitive sensor 22 and the second capacitive sensor 24. According to a variant not shown, these gaps have different lengths.

In the example shown in FIGS. 1 and 2, and by no means limitingly, the second zone 18 of the backrest comprises a second flexible support 30, four capacitive sensors 32, 34, 36, 38 with coplanar interdigital electrodes, hereinafter referred to as “capacitive sensors of the second zone”, and electrical connection wires 37, 39.

The capacitive sensors 32, 34, 36, 38 and electrical connection wires 37, 39 are supported by the second flexible support 30. The second flexible support 30 bears against the foam layer. It is arranged on the upper edge 8 of the backrest on a side of the headrest 7 opposite the side supporting the first flexible support 30.

In the same way as the first zone 16, the second zone 18 comprises a first capacitive sensor 32 of the second zone, located at a second interval 12 from the intersection of the vertical central plane (X, Z) and the plane formed by the seat surface. For example, the second interval 12 is between 4 and 6 centimeters long.

In the example shown in FIGS. 1 and 2, the second interval 12 has the same length as the first interval I1. According to a variant not shown, the second interval 12 has a different length from the first interval I1.

A second capacitive sensor 34 of the second zone is located above the first capacitive sensor 32 of the second zone. The second capacitive sensor 34 of the second zone is advanced by a first distance relative to the first capacitive sensor 32 of the second zone in the direction of the vertical central plane (X, Z). The term “advanced” means “having been shifted”, “having been translated”, “having been moved” in relation to the first capacitive sensor 32 in the transverse direction Y and in the direction of the vertical central plane (X, Z). In other words, the second capacitive sensor 34 of the second zone is closer to the vertical central plane (X, Z) by a spacing having a length equal to the fourth distance D4. The fourth distance D4 is measured in the transverse direction Y. The fourth distance D4 is equal to or greater than 5 millimeters, and preferably equal to or greater than 10 millimeters.

The second capacitive sensor 32 of the second zone is spaced apart from the second capacitive sensor 34 of the second zone by a gap E in the longitudinal direction Z. The gap E is preferably between 5 millimeters and 20 millimeters.

In the embodiment shown by way of example, the gap between the first capacitive sensor 32 of the second zone and the second capacitive sensor 34 of the second zone is identical to the gap between the first capacitive sensor 22 of the first zone and the capacitive sensor 34 of the first zone. Alternatively, the gap between the first capacitive sensor 32 of the second zone and the second capacitive sensor 34 of the second zone, and the gap between the first capacitive sensor 22 of the first zone and the capacitive sensor 34 of the first zone have different lengths.

A third capacitive sensor 36 of the second zone is arranged on the second zone 18. The third capacitive sensor 36 of the second zone is located above the second capacitive sensor 24 of the second zone. The third capacitive sensor 36 of the second zone is advanced by a fifth distance D5 relative to the second capacitive sensor 34 of the second zone in the direction of the vertical central plane (X, Z). The fifth distance D5 is measured in the transverse direction Y. The fifth distance D5 is equal to or greater than 5 millimeters, and preferably equal to or greater than 10 millimeters.

The second capacitive sensor 34 of the second zone is spaced apart from the third capacitive sensor 36 of the second zone by a gap E in the longitudinal direction Z. In the embodiment shown, the gap E between the second capacitive sensor 34 and the third capacitive sensor 36 is identical to the gap between the first capacitive sensor 32 and the second capacitive sensor 34. According to a variant not shown, these gaps have different lengths.

Finally, a fourth capacitive sensor 38 of the second zone is located above the third capacitive sensor 36 of the second zone. The fourth capacitive sensor 38 of the second zone is advanced by a sixth distance D6 relative to the third capacitive sensor 36 of the second zone in the direction of the vertical central plane (X, Z). The sixth distance D6 is measured in the transverse direction Y. The sixth distance D6 is equal to or greater than 5 millimeters, and preferably equal to or greater than 10 millimeters.

In the embodiment shown in FIGS. 1 and 2, the first distance D1 is equal to the second and third distance. Alternatively, the first distance D1 is different from the second distance D2 and the third distance D3.

Alternatively, the second distance D2 is different from the third distance D3.

Similarly, in the embodiment shown in FIGS. 1 and 2, the fourth distance D4 is equal to the fifth distance D5 and the sixth distance D6. Alternatively, the third distance D3 is different from the fifth distance D5 and the sixth distance D6.

Alternatively, the fifth distance D5 is different from the sixth distance D6.

According to a first variant, the first zone 16 comprises two or three capacitive sensors of the first zone offset from one another in the transverse direction Y.

According to a second variant, the first zone 16 and/or the second zone 18 comprises five to eight capacitive sensors of the first zone, all offset from one another in the transverse direction Y.

Alternatively, only one of the first and second zones comprises capacitive sensors.

FIG. 3 shows an example of a capacitive sensor 22 with coplanar interdigital electrodes arranged on the seat according to the present disclosure. This capacitive sensor will not be disclosed in full. In particular, not all these dimensional characteristics will be disclosed in full. Only these special features are disclosed here. Its other features are disclosed in patent application FR3126776 in the name of the applicant.

The coplanar interdigital electrode capacitive sensor 22 comprises a first electrode 40 and a second electrode 42.

The first electrode 40 and the second electrode 42 each comprise a rod 44 and branches 46 attached to the rod. The branches 46 extend perpendicular to the rod 44. The branches 46 of the first electrode are separated from one another by the same interval IN. The branches 46 of the first electrode are interposed between the branches 46 of the second electrode.

The rod 44 of at least one of the first 40 and second 42 electrodes has a dimension ed in a main direction P1 of between 250 micrometers and 1000 micrometers, and preferably between 500 micrometers and 5800 micrometers.

The branches 46 of at least one of the first and second electrodes have a dimension I in the secondary direction P2 of between 3 millimeters and 20 millimeters, and preferably between 3 and 7 millimeters. The secondary direction P2 is perpendicular to the main direction P1.

The branches 46 of the first electrode 40 comprise free ends 48. A free end 48 of a branch of the first electrode is spaced apart from a facing rod portion of the second electrode by a spacing S of between 250 micrometers and 1000 micrometers, and preferably between 500 micrometers and 800 micrometers.

The rods 44 have a length Ltot in the main direction P1 of between 3 and 6 centimeters.

The capacitive sensor 22 has a width Latot in the secondary direction P2 between 0.5 and 2 centimeters.

The present disclosure relates to a device 50 for detecting the size of an occupant of a seat, in particular a motor vehicle seat; the detection device comprises the first flexible support 20 extending in the longitudinal direction Z;
at least the first capacitive sensor 22 and the second capacitive sensor 24, and
electrical connection wires 27, 29 connected to the first capacitive sensor 22 and the second capacitive sensor 24. The electrical connection wires 27, 29 extend in the longitudinal direction Z. The first capacitive sensor and the second capacitive sensor each extend perpendicularly to the longitudinal direction Z.

The second capacitive sensor 24 being advanced by a first distance D1 from the first capacitive sensor 22 in the direction of a lateral edge; the first distance (D1), measured in a transverse direction (Y), being equal to or greater than 5 millimeters, and preferably equal to or greater than 10 millimeters.

The detection device can also comprise all the features mentioned above, and in particular a larger number of capacitive sensors and a second flexible support.

Deployment of the front and side airbags, the front passenger airbag and the seatbelt pretensioning system can cause injury to small passengers such as children. It is therefore desirable to develop devices for detecting the size of the occupant of a motor vehicle seat.

One aim of the present disclosure is to provide a device for detecting the size of a seat occupant and a backrest comprising such a device.

The object of the present disclosure is a seat backrest, in particular a motor vehicle seat backrest, the backrest extending in a longitudinal direction and a transverse direction;
at least one first and one second coplanar interdigital electrode capacitive sensor, referred to as first and second capacitive sensors of the first zone, the capacitive sensors of the first zone being arranged on a first zone of the backrest located above a horizontal central plane and on one side of a vertical central plane;
the second capacitive sensor of the first zone being located above the first capacitive sensor of the first zone;
the second capacitive sensor of the first zone being advanced by a first distance relative to the first capacitive sensor of the first zone in the direction of the central vertical plane.

The features disclosed in the following paragraphs may optionally be implemented. They can be implemented independently of one another or in combination with one another:
the first distance measured in the transverse direction is equal to or greater than 5 millimeters, and preferably equal to or greater than 10 millimeters.
It comprises at least one third coplanar interdigital electrode capacitive sensor, referred to as the third capacitive sensor of the first zone, the third capacitive sensor of the first zone being arranged on the first zone of the backrest, the third capacitive sensor of the first zone being located above the second capacitive sensor of the first zone;
the third capacitive sensor of the first zone being advanced by a second distance relative to the second capacitive sensor of the first zone in the direction of the central vertical plane, the second distance measured in the transverse direction in particular being equal to or greater than 5 millimeters, and preferably equal to or greater than 10 millimeters.
It comprises at least one fourth coplanar interdigital electrode capacitive sensor, referred to as the fourth capacitive sensor of the first zone, the fourth capacitive sensor of the first zone being arranged on the first zone of the backrest, the fourth capacitive sensor of the first zone being located above the third capacitive sensor of the first zone;
the fourth capacitive sensor of the first zone being advanced by a third distance relative to the third capacitive sensor of the first zone in the direction of the central vertical plane, the third distance measured in the transverse direction in particular being equal to or greater than 5 millimeters, and preferably equal to or greater than 10 millimeters.
two capacitive sensors of the first zone, arranged side by side in the longitudinal direction, are spaced apart by a gap of between 5 millimeters and 20 millimeters.
It further comprises at least one first and one second capacitive sensor of the second zone, the first and second capacitive sensors of the second zone being arranged on a second zone of the backrest, the second zone being located above the horizontal central plane and on the other side of the vertical central plane;
the second capacitive sensor of the second zone being located above the first capacitive sensor of the second zone;
the second capacitive sensor of the second zone being advanced by a fourth distance relative to the first capacitive sensor of the second zone in the direction of the central vertical plane, the fourth distance measured in the transverse direction in particular being equal to or greater than 5 millimeters, and preferably equal to or greater than 10 millimeters.
It comprises at least one third coplanar interdigital electrode capacitive sensor, referred to as the third capacitive sensor of the second zone, the third capacitive sensor of the second zone being arranged on the second zone of the backrest, the third capacitive sensor of the second zone being located above the second capacitive sensor of the second zone;
the third capacitive sensor of the second zone being advanced by a fifth distance relative to the second capacitive sensor of the second zone in the direction of the central vertical plane, the fifth distance being measured in the transverse direction, the fifth distance in particular being equal to or greater than 5 millimeters, and preferably equal to or greater than 10 millimeters.
It comprises at least one fourth coplanar interdigital electrode capacitive sensor, referred to as the fourth capacitive sensor of the second zone, the fourth capacitive sensor of the second zone being arranged on the second zone of the backrest, the fourth capacitive sensor of the second zone being located above the third capacitive sensor of the second zone;
the fourth capacitive sensor of the second zone being advanced by a sixth distance relative to the third capacitive sensor; the sixth distance, measured in the transverse direction, is in particular equal to or greater than 5 millimeters, and preferably equal to or greater than 10 millimeters.
At least two capacitive sensors of the first zone and two capacitive sensors of the second zone are arranged symmetrically to one another, relative to the central vertical plane.
It further comprises electrical connection wires each connected to a capacitive sensor of the first zone and/or a capacitive sensor of the second zone, and a flexible support carrying the capacitive sensors and the electrical connection wires, part of the flexible support being arranged on an upper edge of the backrest, next to the headrest.
At least one coplanar interdigital electrode capacitive sensor comprises a first electrode and a second electrode, the first electrode and the second electrode each comprising a rod extending in a main direction, and branches secured to the rod, the branches extending in a secondary direction, the secondary direction being perpendicular to the main direction;
the branches of the first electrode being separated from one another by the same interval, the branches of the first electrode being interposed between the branches of the second electrode, the rod and branches of at least one of the first and second electrodes having a dimension in the main direction of between 250 micrometers and 1000 micrometers, preferably between 500 micrometers and 800 micrometers.
The branches of at least one of the first and second electrodes have a dimension in the secondary direction of between 3 and 20 millimeters, preferably between 3 and 7 millimeters.
The branches of the first electrode comprise free ends, and wherein a free end of a branch of the first electrode is spaced apart from a facing rod portion of the second electrode by a spacing of between 250 micrometers and 1000 micrometers, and preferably between 500 micrometers and 800 micrometers.

The present disclosure also relates to a device for detecting the size of an occupant of a seat, in particular a motor vehicle seat, the detection device comprising:
at least one flexible support in the form of a strip with two lateral edges, the flexible support extending in a longitudinal direction;
at least one first and one second coplanar interdigital electrode capacitive sensor, referred to as first and second capacitive sensors, and
electrical connection wires connected to the first and second capacitive sensors and extending in the longitudinal direction, the first and second capacitive sensors extending perpendicular to the longitudinal direction;
the second capacitive sensor being advanced by a first distance from the first capacitive sensor in the direction of a lateral edge, the first distance, measured in a transverse direction, being equal to or greater than 5 millimeters, and preferably equal to or greater than 10 millimeters.

The present disclosure relates to a seat backrest, the backrest extending in a longitudinal direction (Z) and a transverse direction (Y), the backrest comprising:
at least one first and one second coplanar interdigital electrode capacitive sensor arranged on a first zone (16) of the backrest located above a horizontal central plane (X, Y) and on one side of a vertical central plane (X, Z);
the second capacitive sensor of the first zone being located above the first capacitive sensor of the first zone;
the second capacitive sensor of the first zone being advanced by a first distance relative to the first capacitive sensor of the first zone in the direction of the central vertical plane (X, Z).

1. A seat backrest, the seat backrest extending in a longitudinal direction and a transverse direction;
at least one first and one second coplanar interdigital electrode capacitive sensor, referred to as first and second capacitive sensors of the first zone, the capacitive sensors of the first zone being arranged on a first zone of the backrest located above a horizontal central plane and on one side of a vertical central plane;
the second capacitive sensor of the first zone being located above the first capacitive sensor of the first zone;
the second capacitive sensor of the first zone is advanced by a first distance relative to the first capacitive sensor of the first zone in the direction of the vertical central plane.

2. The seat backrest of claim 1, wherein the first distance measured in the transverse direction is equal to or greater than 5 millimeters.

3. The seat backrest of claim 2, which comprises at least one third coplanar interdigital electrode capacitive sensor, referred to as the third capacitive sensor of the first zone, the third capacitive sensor of the first zone being arranged on the first zone of the backrest, the third capacitive sensor of the first zone being located above the second capacitive sensor of the first zone;
the third capacitive sensor of the first zone being advanced by a second distance relative to the second capacitive sensor of the first zone in the direction of the central vertical plane, the second distance measured in the transverse direction being equal to or greater than 5 millimeters.

4. The seat backrest of claim 3, which comprises at least one fourth coplanar interdigital electrode capacitive sensor, referred to as the fourth capacitive sensor of the first zone, the fourth capacitive sensor of the first zone being arranged on the first zone of the backrest, the fourth capacitive sensor of the first zone being located above the third capacitive sensor of the first zone;
the fourth capacitive sensor of the first zone being advanced by a third distance relative to the third capacitive sensor of the first zone in the direction of the central vertical plane, the third distance measured in the transverse direction being equal to or greater than 5 millimeters, and preferably equal to or greater than 10 millimeters.

5. The seat backrest of claim 1, wherein two capacitive sensors of the first zone, arranged side by side in the longitudinal direction, are spaced apart by a gap of between 5 millimeters and 20 millimeters.

6. The seat backrest of claim 1, which further comprises at least one first and one second capacitive sensor of the second zone, the first and second capacitive sensors of the second zone being arranged on a second zone of the backrest, the second zone being located above the horizontal central plane and on the other side of the vertical central plane;
the second capacitive sensor of the second zone being located above the first capacitive sensor of the second zone;
the second capacitive sensor of the second zone being advanced by a fourth distance relative to the first capacitive sensor of the second zone in the direction of the central vertical plane, the fourth distance measured in the transverse direction in particular being equal to or greater than 5 millimeters.

7. The seat backrest of claim 6, which comprises at least one third coplanar interdigital electrode capacitive sensor, referred to as the third capacitive sensor of the second zone, the third capacitive sensor of the second zone being arranged on the second zone of the backrest, the third capacitive sensor of the second zone being located above the second capacitive sensor of the second zone;
the third capacitive sensor of the second zone being advanced by a fifth distance relative to the second capacitive sensor of the second zone in the direction of the central vertical plane, the fifth distance being measured in the transverse direction, the fifth distance being equal to or greater than 5 millimeters.

8. The seat backrest of claim 7, which comprises at least one fourth coplanar interdigital electrode capacitive sensor, referred to as the fourth capacitive sensor of the second zone, the fourth capacitive sensor of the second zone being arranged on the second zone of the backrest, the fourth capacitive sensor of the second zone being located above the third capacitive sensor of the second zone;
the fourth capacitive sensor of the second zone being advanced by a sixth distance relative to the third capacitive sensor, the sixth distance, measured in the transverse direction, is equal to or greater than 5 millimeters.

9. The seat backrest of claim 6, wherein at least two capacitive sensors of the first zone and two capacitive sensors of the second zone are arranged symmetrically to one another, relative to the central vertical plane.

10. The seat backrest of claim 1, which further comprises electrical connection wires each connected to a capacitive sensor of the first zone and/or a capacitive sensor of the second zone, and a flexible support carrying the capacitive sensors and the electrical connection wires, part of the flexible support being arranged on an upper edge of the backrest, next to the headrest.

11. The seat backrest of claim 1, wherein at least one coplanar interdigital electrode capacitive sensor comprises a first electrode and a second electrode, the first electrode and the second electrode each comprising a rod extending in a main direction, and branches secured to the rod, the branches extending in a secondary direction, the secondary direction being perpendicular to the main direction;
the branches of the first electrode being separated from one another by the same interval, the branches of the first electrode being interposed between the branches of the second electrode, the rod and branches of at least one of the first and second electrodes having a dimension in the main direction of between 250 micrometers and 1000 micrometers.

12. The seat backrest of claim 9, wherein the branches of at least one of the first and second electrodes have a dimension in the secondary direction of between 3 millimeters and 20 millimeters.

13. The seat backrest of claim 9, the branches of the first electrode comprise free ends, and wherein a free end of a branch of the first electrode is spaced apart from a facing rod portion of the second electrode by a spacing of between 250 micrometers and 1000 micrometers.

14. The seat backrest of claim 2, wherein the first distance is equal to or greater than 10 millimeters.

15. The seat backrest of claim 3, wherein the second distance is equal to or greater than 10 millimeters.

16. The seat backrest of claim 4, wherein the third distance is equal to or greater than 10 millimeters.

17. The seat backrest of claim 6, wherein the fourth distance is equal to or greater than 10 millimeters.

18. The seat backrest of claim 7, wherein the fifth distance in is equal to or greater than 10 millimeters.

19. The seat backrest of claim 8, wherein the sixth distance is equal to or greater than 10 millimeters.

20. The seat backrest of claim 11, wherein the dimension in the main direction is comprised between 500 micrometers and 800 micrometers.

21. The seat backrest of claim 12, wherein the dimension in the secondary direction is comprised 3 and 7 millimeters.

22. The seat backrest of claim 13, wherein the spacing is comprised between 500 micrometers and 800 micrometers.

23. A device for detecting the size of an occupant of a motor vehicle seat, the detection device comprising:
at least one flexible support in the form of a strip with two lateral edges, the flexible support extending in a longitudinal direction at least one first and one second coplanar interdigital electrode capacitive sensor, referred to as first and second capacitive sensors, and
electrical connection wires connected to the first and second capacitive sensors and extending in the longitudinal direction, the first and second capacitive sensors extending perpendicular to the longitudinal direction;
the second capacitive sensor being advanced by a first distance from the first capacitive sensor in the direction of a lateral edge; the first distance, measured in a transverse direction, being equal to or greater than 5 millimeters.

24. The device of claim 23, wherein the first distance is equal to or greater than 10 millimeters.
